(19) United States
(12) Patent Application Publication
(10) Pub. No.: US 2026/0326155 A1
(43) Pub. Date: Oct. 22, 2026

(54) TORNADO MACROFOULING COLLECTOR

(71) Applicant: ECOsubsea AS, Torangsvåg (NO)

(72) Inventors: Tor Mikal ØSTERVOLD, Storebø (NO); Klaus ØSTERVOLD, Bergen (NO)

(21) Appl. No.: 18/994,351

(22) PCT Filed: Jul. 6, 2023
(86) PCT No.: PCT/NO2023/060015

§ 371 Date: Jan. 14, 2025

(30) Foreign Application Priority Data
Jul. 15, 2022 (NO) 20220801

(51) Int. Cl. B08B 1/16; B08B 15/04; B63B 59/08

(52) U.S. Cl. CPC B08B 1/165; B08B 15/04; B63B 59/08

(57) ABSTRACT

Tornado macrofouling cutter, for cutting, transporting away and collecting macrofouling on rigid structures submerged into water, such as submerged parts of FPSOs, pontoons, platform legs, quay sides, piles, rigid anchoring structures and/or submerged parts of floating windmills, wherein macrofouling is marine growth beyond algae and bacteria films and involves larger organisms, including hard organisms such as live shells, kelp, seaweed and/or numerous organisms that may grow extensively, wherein macrofouling in the context of the present invention is defined as biofouling comprising organisms of largest dimension larger than 1 cm covering over 50% of the area to be cleaned, with species that adhere to an underlaying structure.

### TECHNICAL FIELD

The present invention relates to removal and collection of biofouling from structures submerged in water, such as vessels and other structures in operation on the ocean.

### BACKGROUND ART

So far, the tool and method as described and illustrated in patent publication EP 2531401 B1 of the applicant, probably represents state of the art in safe removal and collection of biofouling on ships. By commercial operation of said tool and method, fuel consumption by ships can be reduced by up to 20%, by reduced friction after biofouling removal from the ship hull, and all removed biofouling is collected, eliminating spreading of unwanted marine growth species from one location to another, including pathogens and parasites.

However, operation of more stationary structures than ships in regular traffic do not result in the same problems of excessive fuel consumption or unwanted spreading of marine species from one location to another. Such more stationary structures are for example floating petroleum production facilities, such as FPSOs, many drilling rigs, floating wind turbine substructures, semi submerged structures or structures standing on the seabed or otherwise relatively stationary positioned. Many of these structures are never moved during the operational life and the submerged parts thereof are often allowed to accumulate extensive quantities of marine growth.

However, some structures are moved more frequently, such as some semi submersibles and many movable drilling rigs. Such structures may hold numerous species and whole marine ecosystems, which can be transported and spread to new sites. The quantity of biofouling on a large drilling rig or semisubmersible can be tens to hundreds of tons. Structures can be moved thousands of kilometers for new contracts or for decommissioning. Decommissioning often involves sinking large structures into deep fjords or ocean areas, such as deep Norwegian fjords or in waters around the Canary Islands. Unlike regulations for ships in regular traffic, very few regulations limit the unwanted spreading of marine biology by decommissioning or moving said structures. Unintentionally introduced sea vomit is the most recent significant problem in Norwegian waters.

In addition, the overconsumption of fuel due to said severe biofouling can be above 100%. And the weight and/or drag by said severe biofouling may require heavier structures with thicker walls and strength elements. The effects on clime and the native biological systems are significant and negative.

The accumulated biofouling will after some time be dominated by relatively large, hard organisms such as shellfish and clams, in addition to kelp and other living marine organisms of a plurality of species. Such marine biofouling is in this context termed macrofouling.

The tool and method as described and illustrated in patent publication EP 2531401 B1 typically includes nozzles for high pressure jetting of water and/or brushes, for biofouling removal, which are very effective on surfaces with relatively soft and small size biofouling. However, when the biofouling becomes macrofouling, dominated by thick layers of large organisms, including hard organisms such as live shells, kelp, seaweed and numerous organisms that may grow extensively, the normal tools and methods used on ships are no longer very effective.

Apparently, no clear definition exists on the term macrofouling except that it includes marine growth beyond algae and bacteria films and involves larger organisms.

In this context, macrofouling is defined as biofouling comprising organisms of largest dimension larger than 1 cm covering over 50% of the area to be cleaned, with species that adhere to an underlaying structure. Macrofouling cannot easily be removed by high pressure jetting and/or brushing.

Relevant art has been identified as patent publications CN 113173229 A, WO 2015031933 A1, US 2012006244 A1, US 693242 A and EP 2531401 B1.

A demand exists for technology particularly feasible for removing and collecting macrofouling from submerged structures, such as rigid and in principle stationary structures submerged into water.

### SUMMARY OF INVENTION

The demand is met by the present invention.

More specifically, the invention provides a tornado macrofouling cutter, for cutting, transporting away and collecting macrofouling on rigid structures submerged into water, such as submerged parts of FPSOs, pontoons, platform legs, quay sides, piles, rigid anchoring structures, risers, heat exchangers and/or submerged parts of floating windmills, wherein macrofouling is marine growth beyond algae and bacteria films and involves larger organisms, including hard organisms such as live shells, kelp, seaweed and/or numerous organisms that may grow extensively, wherein macrofouling in the context of the present invention is defined as biofouling comprising organisms of largest dimension larger than 1 cm covering over 10% (but typically more than 50%) of the area to be cleaned, with species that adhere to an underlaying structure.

The tornado macrofouling cutter is distinctive in that it comprises:
an inlet suction volume,
an outlet suction pipe arranged to the inlet suction volume and
   operatively coupled to a suction device such as a suction pump, wherein the suction pump or suction device in operation provides an under pressure in the inlet suction volume compared to the pressure outside the inlet suction volume, and
a macrofouling cutter arranged at or in an inlet to the inlet suction volume for cutting macrofouling loose from the structure being cleaned for macrofouling, wherein cut macrofouling is retained inside the inlet suction volume, helped by said under pressure, and is transported away through the outlet suction pipe, preferably to a remote macrofouling collection facility, on a deck of the structure being cleaned for macrofouling or on a service vessel, a barge or on a quay with macrofouling collection facilities or to other feasible location.

The tornado macrofouling cutter is a tool or system for cutting macrofouling loose from a submerged surface or a surface in the splash zone, collecting the cut macrofouling and transporting the cut macrofouling, preferably to a collection facility, without spreading the cut macrofouling into the surrounding water and without clogging the tool or the outlet suction pipe.

The macrofouling cut loose is removed with water flowing into the suction volume and further out from the suction volume through the suction pipe to a collection facility; or if allowable, the macrofouling can be disposed of. If any risk of unwanted spreading of biology (unwanted species, including parasites and pathogens), and/or if the regulations define so, the macrofouling is collected, preferably as sorted, and is used as found appropriate. If no risk for unwanted spreading of biology, for example when removing macrofouling from a stationary FPSO on the site, and if the regulations permit, the macrofouling may be disposed of on site, since the macrofouling only includes local biology of the site. Colleting the macrofouling also leads to collecting any polymers or micropolymers collected by the biological species or removed from the coating, disposal of which polymers may be illegal.

The inlet to the inlet suction volume can have many shapes but is preferably elongated and preferably the long side facing the surface to be cleaned for macrofouling preferably has shape matching or corresponding to the shape of said surface. The other sides can be curved, spherical, half elliptic, trapeze-shaped or other shape.

The tornado macrofouling cutter is also termed tornado macrofouling collector, or tornado macrofouling cutter and collector or just macrofouling cutter and/or collector, since all or most commercial embodiments includes collecting the macrofouling. The different terms are synonyms in this context.

In one preferable embodiment, the tornado macrofouling cutter comprises a macrofouling cutter, such as a cutting edge, arranged on one side of a in substance rectangular inlet opening to the inlet suction volume, preferably on the long rectangle side facing the structure to be cleaned during operation. Having the macrofouling cutter on or integrated into the side of the inlet opening facing the surface to be cleaned, results in no or little additional structure and relatively easy replacing and/or sharpening of the cutting edge or other embodiments of the macrofouling cutter. Alternatively, the macrofouling cutter, such as a cutting edge, can be arranged on additional structure inside the periphery of the inlet opening or a short distance in front of the inlet opening, in the direction for moving the tornado macrofouling collector during operation.

Preferably, the tornado macrofouling collector comprises a cutting edge, with plain or serrated edge or a combination of plain and serrated edge, fixed to the inlet, following the movements of the tornado macrofouling collector; and/or also moveable relative to the inlet, moving perpendicular to and/or along the movement of the inlet in addition to following the movements of the tornado macrofouling collector, further comprising a drive mechanism operatively coupled to the cutting edge.

In some preferable embodiments of the tornado macrofouling collector of the invention, the macrofouling cutter comprises a multicutter. The most preferable embodiments comprise static structure relative to the tornado macrofouling collector, combined with moving structure relative to the tornado macrofouling collector arranged just above the static structure. One preferable embodiment comprises sliding comb teeth or parallel ski-structures oriented out from and directed parallel to the direction of moving the tornado macrofouling collector during operation, pointing in the direction the macrofouling cutter/collector is moved. One embodiment comprises transversely moving cutters arranged just above said static structure. Another embodiment comprises rotating cutters arranged just above said static structure, sliding on the surface being cleaned, arranged for example in two rows, displaced to cut the roots of all macrofouling. When the tornado macrofouling collector is moved forward during operation, the roots of the macrofouling, such as roots of shellfish and kelp and weed, become arranged between said comb teeth or skis or similar structure, wherein the relatively moving parts, said transverse and/or rotating cutters or similar, cut said roots. In some embodiments, said static comb teeth or skis are not sharp in front but preferably rounded and unsharp, but are preferably shaped as converging knives towards the inner end nearest to the inlet suction volume and/or knife edges are arranged as directed forwards in the direction of operation between said comb teeth or skis, to facilitate cutting macrofouling roots and prevent clogging of excessive quantities of macrofouling roots between said comb teeth or skis, while also minimizing risk of damaging coating on the structure being cleaned.

The tornado macrofouling collector can also be feasible for macrofouling collecting from structures that are not rigid and/or less stationary, and for removal of biofouling in general, with or without further biofouling removal tools than the macrofouling cutter. For example, one or two rows of cleaning tools according to the teaching of EP 2531401 B1 can be operatively and removably arranged in front of the inlet of the tornado macrofouling cutter when the biofouling includes significant quantities of soft biofouling films or microfouling, wherein microfouling is biofouling too small to be within the definition of macrofouling. For said operative arranging, high pressure water can preferably be coupled to nozzles of the tools according to the teaching of EP 2531401 B1, if such nozzles are included in said tool embodiment, and the suction out from said tools can be connected to the outlet suction pipe of the tornado macrofouling collector. Accordingly, the tornado macrofouling collector can comprise high pressure jets, cavitation jets, and/or brushes, in addition to or as tools temporarily replacing the normal macrofouling cutter, for cleaning structure with relatively less demanding biofouling to remove.

Protection cover for cutters are included in some embodiments, to reduce the risk of for example kelp to filter into or wind around the cutter structure or other structure at or near the inlet.

One or two or further rotating rollers with corrugations and/or holes and/or slits, for lifting up macrofouling for the cutters, are included for some preferable embodiments.

In some preferable embodiments, the tornado macrofouling cutter comprises a frame or shovel-like structure, replaceable and operatively arranged in front of the inlet and having macrofouling cutters, multicutters, high pressure jets, cavitation jets, and/or brushes in any combination arranged, for providing versatility.

The tornado macrofouling collector can for some embodiments be operated by divers, but preferably further comprises a drive mechanism for moving the tornado macrofouling collector along or onto the structure surface to be cleaned for macrofouling. Preferably, the drive mechanism is an ROV to which the tornado macrofouling collector is arranged, or an ROT-a remotely operated tool, or a manipulator arm, such as an excavator arm arranged on a barge or on a quay. The ROV and/or ROT is moved by thrusters and/or magnetic devices such as magnetic wheels or magnetic devices of other types, including an operatively arranged drive mechanism or not. Other embodiments can be moved by gravity and a winch or crane mechanism.

The tornado macrofouling collector preferably further comprises a macrofouling sorting device, such as sorting screens, for example shaker screens, and/or a macrofouling storage structure, for example a container or several containers for specific types of macrofouling, or flexible bags, operatively arranged, wherein said containers or bags preferably comprises openings for draining water.

Some preferable embodiments of the tornado macrofouling cutter comprises a double version, with one inlet in either end of the inlet volume or two parallel inlet volumes and/or tornado macrofouling cutters, preferably arranged on an ROV with one inlet facing one direction of the ROV to move and the other inlet facing the opposite direction, for allowing macrofouling cutting in both directions. A closing valve/baffle or mechanism can be required for the side or tool not in operation. A common suction pump is preferable, or for redundance parallel process trains are arranged so as to include two suction pumps with outlets converging. Such double tool may improve productivity and redundancy at the same time.

Preferably, the tornado macrofouling collector comprises an inlet suction volume that is smaller in width at top and wider at bottom, with the lower elevation parts extending further forward, in the direction the tornado macrofouling collector is moved, than the higher elevation part, as seen when in normal operation. By normal operation, the long sides are more or less vertical. On vertical structures, such as a hull side, the orientation can be vertical. This feature ensures better collecting, due to taking advantage of both gravity and suction. More specifically, macrofouling cut loose sinks down from the cutting edge by gravity, as long as there is a downwards vertical direction component towards the suction outlet, in addition to being sucked in by underpressure in the outlet suction pipe at a low elevation.

Preferably, the outlet suction pipe arranged to the inlet suction volume and operatively coupled to a suction pump or device, has inlet at a low elevation, most preferably a lowest elevation, of the inlet suction volume, as seen in normal operation. Normal operations means that the tornado macrofouling collector inlet has a vertical direction component in the direction of the cutter, such as when removing macrofouling from a vertical ship hull or other surface with a vertical direction component, wherein both gravity and suction contributes to collecting the macrofouling cut loose. For surfaces oriented horizontal, facing downwards, the gravity will also contribute since the outlet suction pipe inlet is at lower elevation than the surface. For horizontal surfaces facing upwards, typically only suction contributes to said collecting, since the outlet suction pipe inlet is at higher elevation.

Preferably, the suction pump or suction device is a heavy-duty pump, such as a so-called fish pump or a dredging pump, both of which can tolerate relatively large objects without clogging and being commercially available from several suppliers.

The suction pump or suction device in operation provides an underpressure in the inlet suction volume, sufficiently large to avoid escape of macrofouling cut loose by the macrofouling cutter. Preferably, the suction effect is adjustable, such as by an adjustable speed or frequency drive. The actual flow rate to provide sufficient suction to ensure efficient suction of loosened macrofouling into the inlet opening, further into the inlet inlet suction volume, and further into the outlet suction pipe arranged to the inlet suction volume, will vary according to size of the tornado macrofouling collector, the type of macrofouling and the orientation of the tornado macrofouling collector. A range of flow rate of 1-15, 2-10, or 4-8 m³ per minute will typically be feasible, but the limits can be exceeded for very large or small tornado macrofouling collectors or very demanding macrofouling.

In many preferable embodiments, the tornado macrofouling collector comprises wheels and/or sliding skis or rails on the side facing the rigid surface to be cleaned for macrofouling, preferably with adjustable lift off from said surface, preferably adjustable to ensure cutting of macrofouling in a distance in the range 0-25, 0-20, 0-15 or 0-10 mm from the structure being cleaned for macrofouling, preferably 0-8 mm, more preferably about 0-5 or 0-2 or 0-1 mm. The distance ranges specified, are measured from the top of the coating on the structure to have macrofouling removed, up to the elevation of cutting. This ensures cutting of the roots of the macrofouling without damaging the structure and/or the coating thereon, from where macrofouling is cut and collected. Many species of macrofouling, such as common blue mussels, have roots or threads fastened to the structure to be cleaned, said roots or threads can be the weakest parts of the macrofouling and are easier to cut if cut very close to the surface to be cleaned. In other preferable embodiments, the tornado macrofouling collector comprises a cutting edge resting and sliding against the surface to be cleaned without said wheels and/or sliding skis, wherein the edge is slightly convex as resting on the surface to be cleaned, wherein the cutting of macrofouling is in the range 0-5 or 0-2 or 0-1 mm above or on the surface to be cleaned.

Preferably, the inlet to the inlet suction volume for cutting loose the macrofouling to be collected is shaped in substance like a rectangle with long sides at least 5 or 8 or 10 times longer than the short sides, or other elongated shape, with a cutting edge or other macrofouling cutter replaceable arranged on or at an outer one of the long sides to face the structure to be cleaned during operation, wherein the outlet suction pipe can have inlet arranged at a low or lowest elevation, from the inlet suction volume as seen when operating on a structure having a vertical direction component; wherein operation of the tornado macrofouling collector, for all structures that are in more or less vertical orientation or are in horizontal orientation but facing downwards: suction effect plus gravity ensures no leakage of macrofouling cut loose; wherein for horizontally oriented structures facing upwards, suction effect alone ensures no leakage of macrofouling cut loose, but preferably the suction effect can be adjusted to be sufficient to collect all macrofouling cut loose in all orientations of the structure being cleaned, for the specific macrofouling type to be cut loose and collected.

Preferably, the macrofouling cutter, such as a cutting edge and/or multicutters are replaceable and comprises layers of ceramic cutting edge in between steel layers, and/or high carbon steel cutting edge inside layers of stainless steel, POM or other high strength polymer or material, and/or high strength stainless steel, and/or massive high carbon steel, and/or a wire cutter, such as diamond covered wire cutters, with or without a rotating mechanism providing saw-like movement of the wire in one or two directions.

The invention also provides use of the tornado macrofouling cutter according to the invention, for removing, and preferably collecting, macrofouling on rigid structures submerged into water, such as submerged parts of FPSOs, pontoons, platform legs, quay sides, piles, rigid anchoring structures, risers, heat exchangers and/or submerged parts of floating windmills, and/or for removing, and preferably collecting, macrofouling on flexible or non-rigid structures submerged into water, such as flexible anchoring or riser structures.

### BRIEF DESCRIPTION OF DRAWINGS

FIGS. 1a-1e illustrates a tornado macrofouling collector embodiment according to the invention,

FIGS. 2a-2e illustrates a further embodiment of a tornado macrofouling collector according to the invention, and

FIGS. 3a-3c illustrates details of an embodiment of a tornado macrofouling collector of the invention.

FIG. 4 illustrates an embodiment of a tornado macrofouling collector of the invention, as operatively coupled to an ROV.

FIG. 5 illustrates a submerged structure covered with macrofouling, with and without areas cleaned for macrofouling.

### DETAILED DESCRIPTION OF THE INVENTION

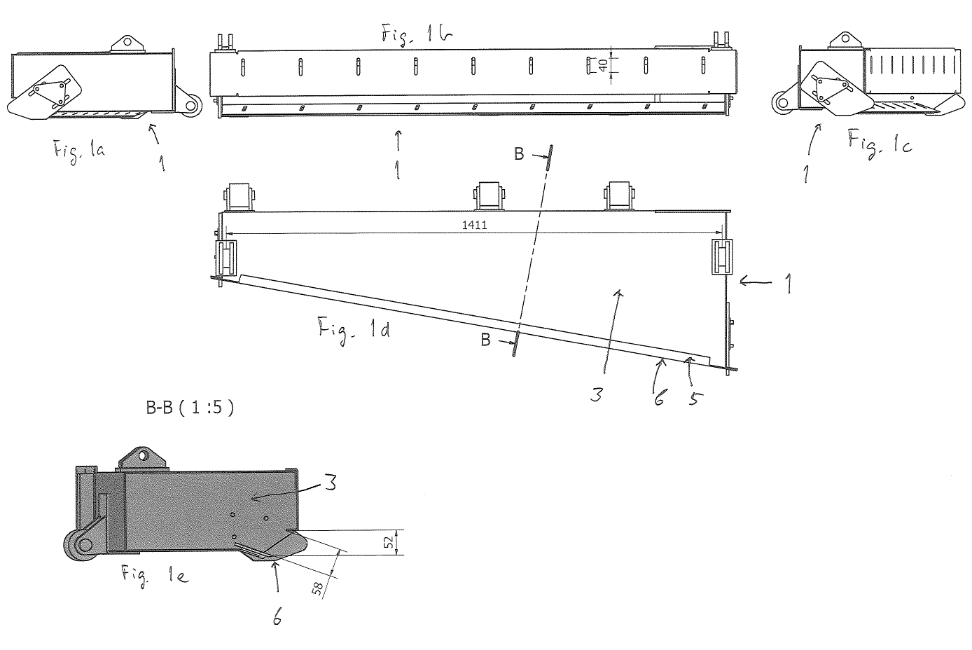

Reference is made to FIGS. 1a-1e, 2a-2e, 3a-3c, 4 and 5, illustrating a tornado macrofouling collector 1, feasible for removing and collecting macrofouling on rigid structures 2 submerged into water, such as submerged parts of FPSOs, pontoons, platform legs, quay sides, piles, rigid anchoring structures and/or submerged parts of floating windmills. The tornado macrofouling collector comprises an inlet suction volume 3, an outlet suction pipe 4 arranged to the inlet suction volume and operatively coupled to a suction device such as a suction pump, and a macrofouling cutting edge 6 arranged at or in an inlet 5 to the inlet suction volume for cutting loose the macrofouling to be collected.

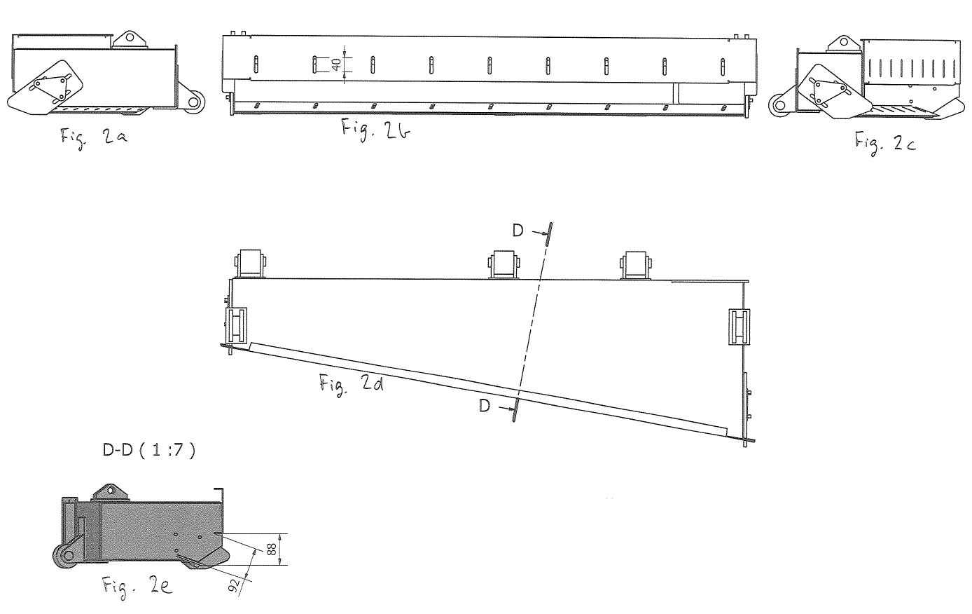

FIGS. 1a-1e and 2a-2e are in substance identical, illustrating two respective embodiments of a tornado macrofouling collector of the invention, with slightly different dimensions. Said figures are as viewed from: as seen from one side: FIGS. 1a and 2a; from front, FIGS. 1b and 2b; from opposite side relative to 1a and 2a, FIGS. 1c and 2c; as viewed from top, FIGS. 1d and 2d; and as cross sections along lines B-B as illustrated on FIGS. 1d and 2d, with said cross-sections illustrated on FIGS. 1e and 2e.

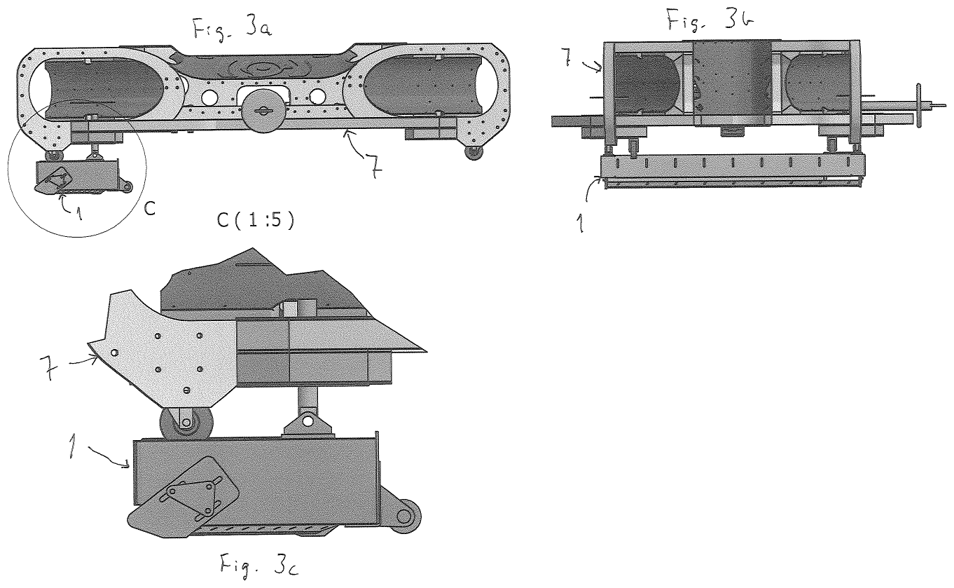

FIGS. 3a-3c illustrate the tornado macrofouling collector 1 as operatively coupled to an ROV 7. The coupling between the tornado macrofouling collector 1 and the ROV comprises a spring-loaded wheel combined with a hinged coupling, providing some flexibility with respect to relative orientation between the tornado macrofouling collector and the ROV, thereby allowing the tornado macrofouling collector to follow the orientation of the structure to be cleaned accurately, with flexibility, if compared with a more rigid coupling.

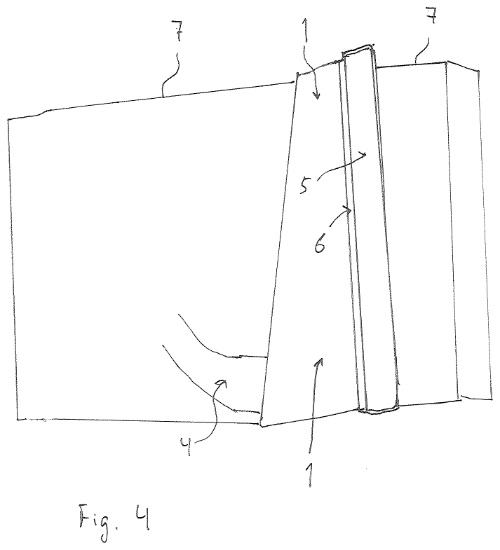

FIG. 4 illustrates an embodiment of a tornado macrofouling collector 1 of the invention, as operatively coupled to an ROV 7. The ROV can hold the macrofouling cutting edge 6 closely against the surface to be cleaned, while moving the ROV and cutting edge forwards, thereby cutting and collecting the macrofouling, and transporting the macrofouling through a suction outlet 4 to a collection position (not illustrated).

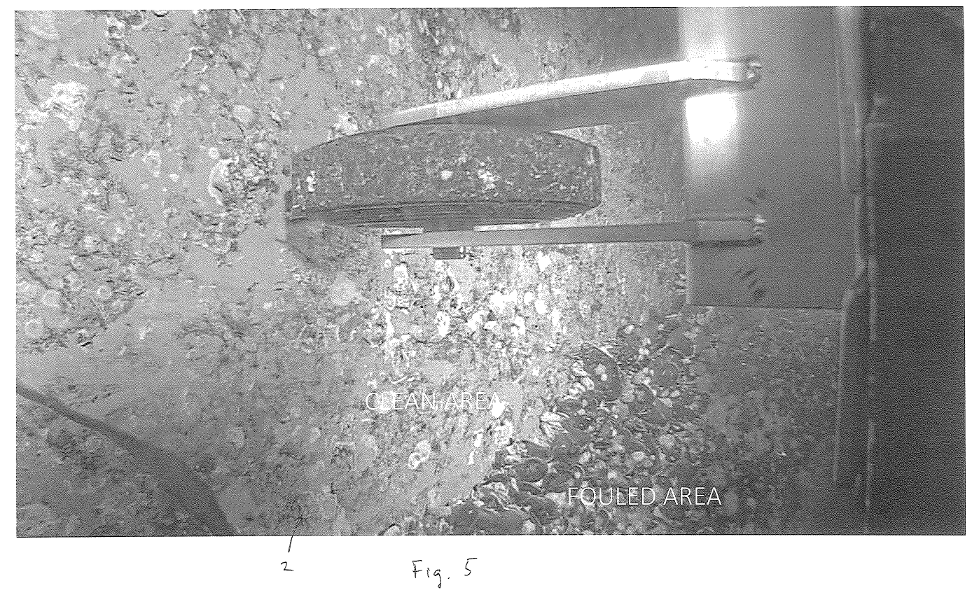

FIG. 5 is a photography illustrating a structure 2, such as a hull side or pontoon side, before and after cleaning the surface from macrofouling by operating the tornado macrofouling collector of the invention.

1. Tornado macrofouling cutter, for cutting, transporting away and collecting macrofouling on rigid structures submerged into water, such as submerged parts of FPSOs, pontoons, platform legs, quay sides, piles, rigid anchoring structures and/or submerged parts of floating windmills, wherein macrofouling is marine growth beyond algae and bacteria films and involves larger organisms, including hard organisms such as live shells, kelp, seaweed and/or numerous organisms that may grow extensively, wherein macrofouling in the context of the present invention is defined as biofouling comprising organisms of largest dimension larger than 1 cm covering over 50% of the area to be cleaned, but typically dominated by thick layers of large organisms being up to and above 1 m in length and covering above 50% of the area to be cleaned, with species that adhere to an underlaying structure,
characterised in that the tornado macrofouling cutter comprises:
an inlet suction volume,
an outlet suction pipe with inlet arranged directly into the inlet suction volume and operatively coupled to a suction device such as a suction pump, wherein the suction pump or suction device is arranged in or to the outlet suction pipe, such as in or to a downstream end or section of the outlet suction pipe, in operation provides an under pressure in the inlet suction volume compared to the pressure outside the inlet suction volume, and
a macrofouling cutter comprising a cutting edge arranged at or in an inlet to the inlet suction volume for cutting macrofouling loose from the structure being cleaned for macrofouling when the tornado macrofouling cutter moves, wherein cut macrofouling is sucked into the inlet opening, further into and retained inside the inlet suction volume and is transported away continuously through the outlet suction pipe, to a macrofouling collection facility, on a deck of the structure being cleaned for macrofouling or on a service vessel or on a quay with macrofouling collection facilities or to other feasible location.

2. Tornado macrofouling cutter according to claim 1, wherein the macrofouling cutter comprises a cutting edge arranged on one side of a in substance rectangular inlet opening to the inlet suction volume, on the side facing the structure to be cleaned during operation, wherein the cutting edge is arranged for cutting of macrofouling in a range 0-5 or 0-2 or 0-1 mm above or on the surface to be cleaned.

3. Tornado macrofouling cutter according to claim 1, wherein a flow rate into and through the inlet suction volume and the outlet suction pipe is at least in a range 1-15, 2-15, 2-10 or 4-8 m³ per minute.

4. Tornado macrofouling cutter according to claim 1, further comprising a drive mechanism for moving the tornado macrofouling cutter along or onto the structure surface to be cleaned for macrofouling, wherein the drive mechanism is an ROV to which the tornado macrofouling cutter is operatively arranged by a coupling and moved whilst the macrofouling is cut and transported away, wherein the coupling between the tornado macrofouling cutter and ROV includes flexibility, by comprising spring loading elements and/or elastomeric elements, for allowing the tornado macrofouling cutter to follow the structure to be cleaned exactly.

5. Tornado macrofouling cutter according to claim 1, comprising a macrofouling collector and a macrofouling sorting device, such as a filter or shaker screens.

6. Tornado macrofouling cutter according to claim 1, comprising an inlet suction volume that is smaller in width at top and wider at bottom, with the lower elevation parts extending further forward than the higher elevation part, as seen when in normal operation on a structure with a vertical direction component.

7. Tornado macrofouling cutter according to claim 1, wherein the outlet suction pipe arranged to the inlet suction volume and operatively coupled to a suction pump or device, such as a heavy duty pump, has inlet at a low elevation, preferably a lowest elevation, of the inlet suction volume, as seen in normal operation on a structure with a vertical direction component or a horizontal structure facing downwards.

8. Tornado macrofouling cutter according to claim 1, wherein the tornado macrofouling cutter comprises wheels and/or sliding skis, adjustable to ensure cutting of macrofouling in a distance in the range 0-5 or 0-2 or 0-1 mm, or the cutting edge rest and slide against the surface to be cleaned without said wheels and/or sliding skis.

9. Tornado macrofouling cutter according to claim 1, wherein the inlet to the inlet suction volume for cutting loose the macrofouling to preferably be collected is shaped in substance like a rectangle with long sides at least 5 or 8 or 10 times longer than the short sides, with a cutting edge or other macrofouling cutter replaceable arranged on or at an outer long side to face the structure to be cleaned during operation, wherein the outlet suction pipe can have inlet arranged at a low or lowest elevation, from the inlet suction volume as seen when operating on a structure having a vertical direction component; wherein operation of the tornado macrofouling cutter, for all structures that are in more or less vertical orientation or are in horizontal orientation but facing downwards: suction effect plus gravity ensures no leakage of macrofouling cut loose; wherein for horizontally oriented structures facing upwards, suction effect alone ensures no leakage of macrofouling cut loose, but preferably the suction effect can be adjusted to be sufficient to collect all macrofouling cut loose in all orientations of the structure being cleaned, for the specific macrofouling type to be cut loose and collected.

10. Use of the tornado macrofouling cutter according to claim 1, for removing and preferably collecting macrofouling on rigid structures submerged into water, such as submerged parts of FPSOs, pontoons, platform legs, quay sides, piles, rigid anchoring structures, risers, heat exchangers and/or submerged parts of floating windmills, and/or for removing and preferably collecting macrofouling on flexible or non-rigid structures submerged into water, such as flexible anchoring or riser structures.

11. Tornado macrofouling cutter according to claim 1, comprising one or two or more of the features as follows, in any combination:
wherein the macrofouling cutter is replaceable,
wherein the macrofouling cutter is arranged on additional structure inside the periphery of the inlet opening or a short distance in front of the inlet opening, in the direction for moving the tornado macrofouling cutter during operation,
wherein the macrofouling cutter cutting edge comprises layers of ceramic cutting edge in between steel layers, and/or high carbon steel cutting edge inside layers of stainless steel, and/or high strength stainless steel, and or massive high carbon steel,
wherein the macrofouling cutter comprising a cutting edge, with plain or serrated edge or a combination of plain and serrated edge, fixed to the inlet, following the movements of the tornado macrofouling collector; or said cutting edge is moveable relative to the inlet, moving perpendicular to and/or along the movement of the inlet, further comprising a drive mechanism operatively coupled to the moveable cutting edge,
wherein the macrofouling cutter comprises a multicutter, comprising static structure relative to the tornado macrofouling collector, combined with moving structure relative to the tornado macrofouling collector arranged just above the static structure, said relatively static structure preferably comprising sliding comb teeth or parallel ski-structures oriented out from and directed parallel to the direction of moving the tornado macrofouling collector during operation, said moving structure preferably comprising transversely moving cutters arranged just above said static structure and/or rotating cutters arranged just above said sliding static structure, preferably said static comb teeth or skis are rounded and unsharp in front but are preferably shaped as converging knives towards the other end and/or knife edges are arranged as directed forwards in the direction of operation between said comb teeth or skis, and/or
a macrofouling collecting facility.
